(19) United States
(12) Patent Application Publication
(10) Pub. No.: US 2026/0210386 A1
(43) Pub. Date: Jul. 23, 2026

(54) FASTENER RETENTION SYSTEM

(71) Applicant: Honeywell International Inc., Charlotte, NC (US)

(72) Inventor: Kevin Bergman, Windermere, FL (US)

(21) Appl. No.: 19/029,461

(22) Filed: Jan. 17, 2025

(51) Int. Cl. F16B 5/02; F16B 13/06

(52) U.S. Cl. CPC F16B 5/0258; F16B 13/068

(57) ABSTRACT

A fastener retention system comprising: a fastener; a recess configured to receive the fastener; and one or more retention elements disposed within the recess, wherein the one or more retention elements are configured to interface with the fastener when the fastener is disposed within the recess to retain the fastener within the recess and inhibit unintended movement of the fastener within the recess.

### TECHNICAL FIELD

The disclosure relates to retention of mechanical fasteners.

### BACKGROUND

Fasteners may be used to secure electronic components to a housing or assembly. There may be a risk of an unauthorized third party tampering with the electronic components by removing the fasteners, removing and tampering with the electronic components, and resecuring the electronic components to the housing or assembly via the fasteners.

### SUMMARY

Fasteners (e.g., screws, bolts, springs, or the like) may be used to secure electronic components (e.g., integrated circuits (ICs), circuit card assemblies (CCAs), printed board assemblies (PBAs)) to a housing and/or assembly. The electronic components may not be removable from the housing and/or assembly without removal of the fasteners. An unauthorized third party and/or a hostile actor may seek to tamper or otherwise alter the electronic components. The third party may seek to remove fasteners to access the electronic components, tamper with the electronic components, replace the electronic components within the housing and/or assembly, and re-affix the fasteners to the housing and/or assembly. In such a manner, an authorized user may not be able to visually determine whether the electronic components have been accessed by an unauthorized party, and may therefore be unable to identify possible tampering with the electronic components.

In some examples, the disclosure describes devices, systems, and techniques for identifying tampering of fasteners within an assembly by unauthorized third parties. The devices, systems, and techniques described herein may determine, based on movement(s) of element(s) within a system, whether fastener(s) have been displaced (e.g., tampered with) within the system and notify an authorized user of displacement of fastener(s) within the system. The authorized user may then be able to determine, based on the notifications of fastener displacements, whether the fastener(s), and by extension the electronic components, have been accessed by an unauthorized third party.

The movement(s) of the element(s) may be randomized or otherwise difficult or impossible to replicate by the unauthorized third party. By making the movement(s) difficult or impossible to replicate, the devices, systems, and techniques described herein may make it more difficult or impossible for an unauthorized third party to remove fastener(s) without generating a notification. The fastener monitoring devices, systems, and techniques described herein may improve the security of electronic components from unauthorized tampering by notifying authorized users of movement of the fasteners within the assembly without increasing a complexity of access to the electronic components by authorized users.

In some examples, the disclosure describes devices, systems, and techniques for retaining fasteners within an assembly. The devices, systems, and techniques described herein may secure fasteners to the assembly and inhibit unauthorized removal of the fasteners by an unauthorized third party. As described herein, the fasteners may be quickly removed via an authorized means but may be difficult or impossible to remove by the unauthorized third party. The fastener retention devices, systems, and techniques described herein may improve the security of electronic components from unauthorized tampering by inhibited unauthorized users from removing the fasteners and thereby access the electronic components.

In some examples, the disclosure describes devices, systems, and techniques incorporating both the fastener monitoring systems and the fastener retaining systems. In such examples, the devices, systems, and techniques may both inhibit the unauthorized removal of the fasteners by the unauthorized party and, in the event that the unauthorized party succeeds in removing the fasteners, notify an authorized user of the removal.

In one example, this disclosure describes a device comprising: a first element configured to contact a component of a system; a second element disposed at least partially within and configured to interface with the first element; and processing circuitry coupled to the first element and the second element, the processing circuitry being configured to: determine a rotation of the second element relative to the first element in response to a movement of the component within the system; and output, based on the determination, a notification indicating a displacement of the component within the system.

In one example, this disclosure describes a device comprising: a first element configured to contact a fastener of a system, wherein the first element is configured to move along a longitudinal axis of the device in response to movement of the fastener within the system; a second element disposed at least partially within and configured to interface with the first element, the second element comprising: an elongated body configured to interface with the first element, a plurality of guide elements extending from the elongated body and defining a plurality of recesses around the elongated body, and a plurality of rotational elements, each rotational element of the plurality of rotational elements being disposed within a corresponding recess of the plurality of recesses, wherein each rotational element is configured to rotate within the corresponding recess; and processing circuitry coupled to the first element and the second element, the processing circuitry being configured to: determine a rotation of one or more rotational elements of the plurality of rotational elements in response to the movement of the fastener; and output, based on the determination, a notification indicating a displacement of the fastener within the system.

In one example, this disclosure describes a device comprising: a first element configured to contact a fastener of a system, wherein the first element is configured to move along a longitudinal axis of the device in response to movement of the fastener within the system; a plurality of rotational elements, wherein at least one rotational element of the plurality of rotational elements is configured to interface with the first element, wherein each rotational element is coupled to at least one other rotational element of the plurality of rotational elements, and wherein each rotational element of the plurality of rotational elements is configured to rotate about the longitudinal axis in response to the movement of the first element along the longitudinal axis; and processing circuitry coupled to the first element and the second element, the processing circuitry being configured to: determine a rotation of one or more rotational elements of the plurality of rotational elements in response to the movement of the fastener; and output, based on the determination, a notification indicating a displacement of the fastener within the system.

In one example, this disclosure describes a device comprising: a first element configured to contact a component of a system; and a second element disposed at least partially within and configured to interface with the first element, wherein the second element is configured to rotate relative to the first element in response to a movement of the component within the system, and wherein the rotation of the second element is configured to provide an indication of a displacement of the component within the system.

In one example, this disclosure describes a fastener retention system comprising: a fastener; a recess configured to receive the fastener; and one or more retention elements disposed within the recess, wherein the one or more retention elements are configured to interface with the fastener when the fastener is disposed within the recess to retain the fastener within the recess and inhibit unintended movement of the fastener within the recess.

In one example, this disclosure describes a fastener retention system comprising: a fastener; a recess; and a locking system disposed within the recess, the locking system comprising: a first sleeve configured to receive the fastener, and a second sleeve disposed within the recess and sized to retain first sleeve, the second sleeve being configured to be removably engaged to the first sleeve; wherein when the second sleeve is engaged to the first sleeve, the locking system allows for movement of the fastener into and out of the locking system, and wherein when the second sleeve is not engaged to the first sleeve, the locking system inhibits the movement of the fastener into and out of the locking system.

In one example, this disclosure describes a fastener retention system comprising: a fastener; a recess configured to receive the fastener; and a locking spring disposed within the recess, wherein the locking spring is configured to envelop the fastener as the fastener enters the recess to secure the fastener within the recess.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a conceptual diagram illustrating an example interface between a fastener and a chassis of a system, in accordance with one or more techniques of this disclosure.

FIG. 2A is a conceptual diagram illustrating an example fastener retention system for the system of FIG. 1.

FIG. 2B is a conceptual diagram illustrating an interface between an example fastener and the example fastener retention system of FIG. 2A.

FIG. 3A is a conceptual diagram illustrating another example fastener retention system for the system of FIG. 1

FIG. 3B is a conceptual diagram illustrating an interface between an example fastener and the example fastener retention system of FIG. 3A.

FIG. 4A is a conceptual diagram illustrating another example fastener retention system for the system of FIG. 1

FIG. 4B is a conceptual diagram illustrating an interface between an example fastener and the example fastener retention system of FIG. 4A.

FIG. 5 is a conceptual diagram illustrating an example fastener monitoring system for the system of FIG. 1.

FIG. 6 is a conceptual diagram illustrating an example of the fastener monitoring system of FIG. 5.

FIG. 7A is a conceptual diagram illustrating another example of the fastener monitoring system of FIG. 5.

FIG. 7B is a cross-sectional diagram illustrating a cross-section of the fastener monitoring system of FIG. 7A, the cross-section being taken along line A-A of FIG. 7A.

FIG. 8A is a conceptual diagram illustrating an exploded view of another example fastener monitoring system of FIG. 5.

FIG. 8B is a conceptual diagram illustrating a top view of the fastener monitoring system of FIG. 8A.

FIG. 9 is a conceptual diagram illustrating an exploded view of another example fastener monitoring system of FIG. 5.

### DETAILED DESCRIPTION

The disclosure describes systems, methods, and devices for identifying and/or preventing unauthorized tampering with fasteners within a system. While the devices, systems, and techniques in this disclosure are primarily described with reference to a computing system (e.g., an avionics system of an aircraft), the devices, systems, and techniques may be applied to other mechanical and/or electromechanical systems to identify and/or prevent tampering of components within the systems.

Fasteners (e.g., screws, bolts, clips, springs, etc.) may be used to secured components within a system and/or assembly. The components may include, but are not limited to, electronic components such as integrated circuits (ICs), computer processors, controllers, microcontrollers, circuit card assemblies (CCAs), printed board assemblies (PBAs), or the like. For example, fasteners may be used to affix electronic components and/or assemblies onto and/or within a housing or a chassis of a computing system (e.g., an avionics system of an aircraft).

An unauthorized third party (e.g., a hostile actor) may seek access to and tamper with the components within the system, e.g., to infiltrate the system, to infect the system, to sabotage the system, to obtain secured information from the system. The unauthorized third party may access the components by tampering with the fasteners of the system (e.g., by removing the fasteners from the system), thereby gaining access to the components and/or assemblies. After the unauthorized third party has finished tampering with and/or accessing the components, the third party may replace the components and/or assemblies within the system and reaffix the fasteners to the system. In such examples, an authorized user of the system may be unable to prevent and/or detect unauthorized access to the components of the system.

In some examples, the disclosure describes a fastener retention system which may secure fasteners to a housing and/or chassis of a system after the fastener has interfaced with the housing and/or chassis (e.g., is disposed within a corresponding recess on the housing and/or chassis). The fastener retention system may secure fasteners, and by extension the components of the computing system, to the housing and/or chassis of the computing system, thereby inhibiting access to the components by an unauthorized third party via tampering with the fasteners of the system.

In some examples, the disclosure describes a fastener monitoring system which may detect displacement of the fasteners within the housing and/or chassis of the system, e.g., to detect occurrences of tampering with the fasteners by the unauthorized third party. The fastener monitoring system may implement non-replicable, randomized, or difficult-to-replicate means of detecting fastener displacement, e.g., to inhibit circumvention of the fastener monitoring system by the unauthorized third party.

In some examples, the disclosure describes inclusion of both a fastener retention system and a fastener monitoring system, e.g., for a same fastener within the system. The inclusion of both systems may inhibit tampering by the unauthorized third party and may provide a notification to an authorized user in the event that the unauthorized third party overcomes the fastener retention system.

The devices, systems, and techniques described herein may provide several technical advantages. In some examples, fastener monitoring system may release fasteners in response to a specific way of interacting with the fastener retention system available to the authorized user, which may allow for easier access to the components within the system by the authorized user while still inhibiting unauthorized access, e.g., by the unauthorized third party. In some examples, the fastener monitoring system may use non-replicable, randomized, or difficult-to-replicate methods to monitor for displacement of fasteners within the system, which may increase the difficulty for circumvention of the fastener monitoring system by the unauthorized third party, e.g., even if the unauthorized third party has access to a physically identical fastener monitoring system.

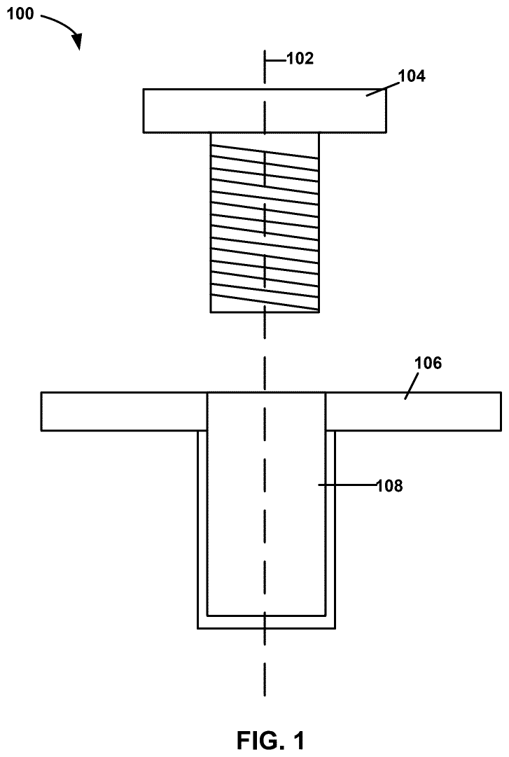

FIG. 1 is a conceptual diagram illustrating an example interface between a fastener 104 and a chassis 106 of a system 100, in accordance with one or more techniques of this disclosure. System 100 may be a mechanical or electro-mechanical system including, but is not limited to, an avionics system for an aircraft or unmanned aerial vehicle (UAV), a control system for a vehicle (e.g., an automobile, a watercraft), a computing system, a micro-electro-mechanical systems (MEMS) device, ICs, CCA, PCBs, or the like.

System 100 may include a chassis 106 (alternatively referred to herein as “housing 106”) and a plurality of components (not pictured in FIG. 1). The plurality of components may include electronic components including, but are not limited to, ICs, PCBs, three-dimensional integrated circuits (3D ICs), processors, controllers, micro-controllers, CCAs, passive components, or the like. The components may be attached to chassis 106 via fasteners 104.

Chassis 106 may define a plurality of receptacles 108 (alternatively referred to herein as “recess 108”), each receptacle 108 being configured to receive a corresponding fastener 104. Receptacle 108 may be integral to chassis 106. In some examples, receptacles 108 may be defined by a separate component affixed to chassis 106 (e.g., press fit into chassis 106, screwed into chassis 106, or affixed to chassis 106 via an adhesive, or welded to chassis 106). An opening to receptacle 108 may be flush with or proud of an upper surface of chassis 106. Fastener 104 may enter receptacle 108 along longitudinal axis 102. As fastener 104 enters receptacle 108, a first set of features along an outer surface of fastener 104 may interface with a second set of features along an inner surface of receptacle 108 to secure fastener 104 to chassis 106. For example, male threads on fastener 104 may engage with female threads within receptacle 108 to secure fastener 104 to chassis 106, or vice versa.

Chassis 106 and/or other components of system 100 may include element(s) (e.g., receptacle 108) with physical reference and/or tracing features. The physical reference and/or tracing features may include, but are not limited to, part numbers, serial numbers, encrypted numbers, or the like. The physical reference and/or tracing features may be accessible by an authorized party, e.g., to monitor a status of system 100. An unauthorized party may not be able to access the physical reference and/or tracing features (e.g., due to the retention of fastener 104 by system 100).

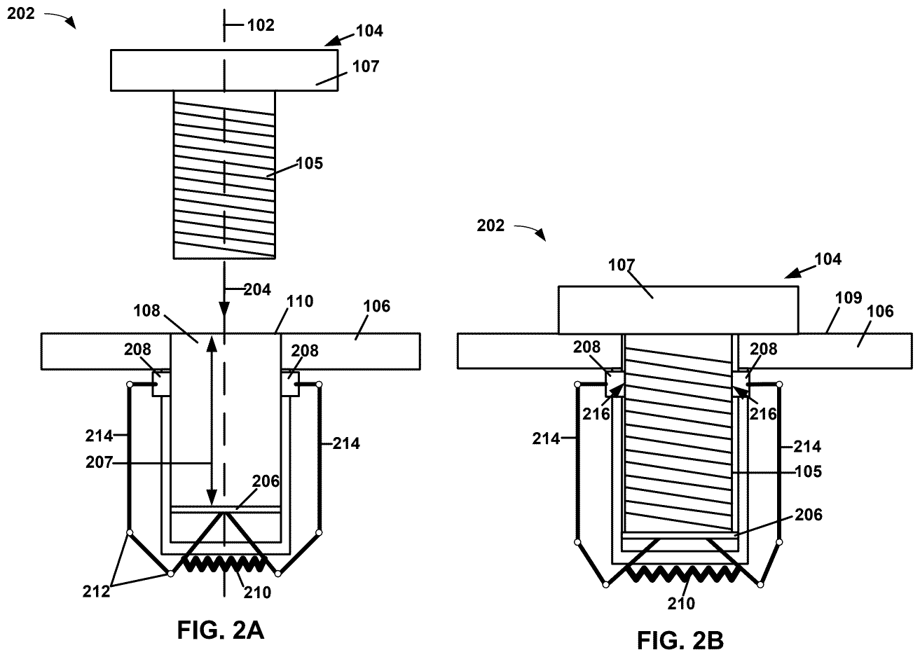

FIG. 2A is a conceptual diagram illustrating an example fastener retention system 202 for system 100 of FIG. 1. FIG. 2B is a conceptual diagram illustrating an interface between fastener 104 and fastener retention system 202 of FIG. 2A. Fastener retention system 202 may be disposed within and/or around receptacle 108. As illustrated in FIGS. 2A and 2B, when fastener 104 enters receptacle 108, elements of fastener retention system 200 may engage with fastener 104, e.g., to inhibit displacement of fastener 104 out of receptacle 108.

Fastener retention system 202 may be inserted into or around receptacle 108. In some examples, fastener retention system 202 is integral to receptacle 108. Fastener retention system 202 may include a first element 206 (alternatively referred to herein as “plate 206”) coupled to one or more second elements 208 (alternatively referred to herein as “block(s) 208” or “clamp(s) 208”) via linkage(s) 214. Linkage(s) 214 may be connected via levers, joints 212, spring(s) 210, pivot points, or the like.

Plate 206 may be floating and/or movable within receptacle 108. Plate 206 may be positioned within receptacle 108 and along longitudinal axis 102 such that a distance 207 between an upper surface of plate 206 and opening 110 of receptacle 108 is less than a longitudinal length of a portion of fastener 104 configured to be disposed within receptacle 108 (e.g., shank 105 of fastener 104). Plate 206 may be kept at the specific position within receptacle 108 via linkage(s) 214 and spring(s) 210. For example, spring(s) 210 may exert a spring force on linkage(s) 214 to keep linkage(s) 214 in a specific orientation relative to longitudinal axis 102, thereby causing plate 206 connected to linkage(s) 214 to maintain the specific position within receptacle 108.

As fastener 104 enters receptacle 108 along longitudinal axis 102 in direction 204, an end of fastener 104 may contact a surface of plate 206. As fastener 104 advances further within receptacle 108, fastener 104 may push plate 206 down in direction 204 towards a bottom of receptacle 108. As plate 206 is pushed towards the bottom of receptacle 108, plate 206 may cause linkage(s) 214 connected to plate 206 to (e.g., through joints 212), to push block(s) 208 into receptacle 108, e.g., towards shank 105 of fastener 104. In some examples, plate 206 transfers a received force from fastener 104 to linkage(s) 214 through spring(s) 210.

When block(s) 208 are pushed at least partially into receptacle 108, block(s) 208 may apply a force orthogonal to and towards longitudinal axis 102 on fastener 104 along surfaces 216, e.g., thereby inhibiting displacement of fastener 104 out of receptacle 108. Block(s) 208 may clamp around fastener 104 along surfaces 216. In some examples, as illustrated in FIG. 2B, two or more blocks 208 apply a compressive force on fastener 104 to secure fastener 104 within receptacle 108. When linkage(s) 214 push block(s) 208 at least partially into receptacle 108, block(s) 208 may define a locking collar around fastener 104 (e.g., around shank 105 of fastener 104). Block(s) 208 may define a locking collar around at least a portion of an outer perimeter of shank 105 (e.g., around the entire outer perimeter of shank 105). Fastener retention system 202 may be positioned within receptacle 108 such that when surfaces 216 of block(s) 208 contact fastener 104, a head 107 of fastener 104 is in contact with an outer surface 109 of chassis 106.

In some examples, fastener retention system 202 may retract block(s) 208 from fastener 104, e.g., to allow for retraction of fastener 104 from within receptacle 108. One or more retraction elements (not pictured in FIGS. 2A, 2B) may engage with linkage(s) 214 and retract linkage(s) 214, e.g., to cause block(s) 208 to retract from fastener 104. The one or more retraction elements may engage with linkage(s) 214 via a locking feature, via a ratcheting feature, or the like. The one or more retraction elements may be operated by an authorized user of system 100 (e.g., via a specific tool, via one or more other elements within system 100) to retract block(s) 208. When block(s) 208 are in a retracted configuration (e.g., as illustrated in FIG. 2A), fastener 104 may be removed from within receptacle 108. When fastener 104 is removed from within receptacle 108, the one or more retraction elements may release linkage(s) 214, e.g., to cause plate 206 to reset to the specific configuration within receptacle 108. The one or more retraction elements may not be engageable (e.g., without a specific tool) from outside of receptacle 108. In some examples, the one or more retraction elements may be engaged via unlocking of a locking mechanism by an authorized party. The locking mechanism may include a mechanical and/or electrical lock including, but are not limited to, encrypted combination locks, randomized combination locks, or the like. The authorized party may unlock the locking mechanism via an encryption key possessed by the authorized party.

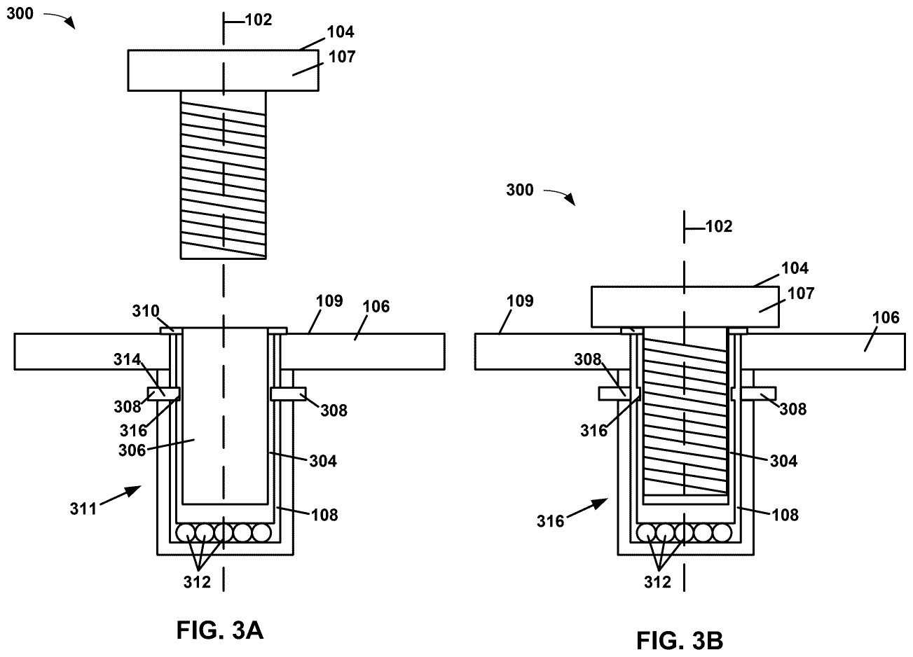

FIG. 3A is a conceptual diagram illustrating another example fastener retention system 300 for system 100 of FIG. 1. FIG. 3B is a conceptual diagram illustrating an interface between fastener 104 and fastener retention system 300 of FIG. 3A. FIG. 3A illustrates fastener retention system 300 in an example locked configuration and FIG. 3B illustrated fastener retention system 300 in an example unlocked configuration.

System 300 may include an inner retainer 304 (alternatively referred to herein as “inner sleeve 304”) disposed within receptacle 108. Inner retainer 304 may define an inner receptacle 306 configured to receive fastener 104. For example, threads around an inner surface of inner receptacle 306 may be configured to interface with corresponding threads on an outer surface of fastener 104 to receive fastener 104 within inner retainer 304. Inner retainer 304 may be removably inserted into receptacle 108 or may be integral to inner receptacle. An outer lip 310 of inner retainer 304 may extend past outer surface 109 of chassis 106.

Inner retainer 304 may be configured to freely rotate within receptacle 108 when fastener retention system 300 is in the unlocked configuration. One or more rotational elements may be disposed between inner retainer 304 and receptacle 108, e.g., to allow for the rotation of inner retainer 304 relative to receptacle 108. The one or more rotational elements may include, but is not limited to, bearings 312. In some examples, a ratchet device and/or assembly may be disposed between inner retainer 304 and inner receptacle 306, e.g., to maintain compression against fastener 104. When fastener 104 is disposed within inner retainer 304, fastener 104 and inner retainer 304 may rotate about longitudinal axis 102. Outer lip 310 of inner retainer 304 may separate at least a portion of fastener 104 (e.g., head 107 of fastener 104) from chassis 106 (e.g., from surface 109 of chassis 106), e.g., thereby preventing chassis 106 from impeding the rotation of fastener 104. If an unauthorized party attempts to remove fastener 104 from system 100 (e.g., by applying torque on fastener 104), fastener 104 and inner retainer 304 may rotate in response and inhibit displacement of fastener 104 within inner receptacle 306 of inner retainer 304. The ability of fastener 104 and inner retainer 304 to freely rotate within receptacle 108 may make it difficult or impossible for the unauthorized third party to remove fastener 104 from system 100.

Locking blocks(s) 308 may engage inner retainer 304 to an outer retainer 311 of fastener retention system 300. Outer retainer 311 may be disposed radially outwards of inner retainer 304 and may be configured to receive inner retainer 304. In some examples, as illustrated in FIGS. 3A, 3B, outer retainer 311 may be receptacle 108. In some examples, outer retainer 311 is disposed within receptacle 108 and inner retainer 304 is disposed within outer retainer 311. Outer retainer 311 may not be configured to rotate relative to receptacle 108 and/or chassis 106.

When inner retainer 304 is not engaged with outer retainer 311 (e.g., when fastener retention system 300 is in the unlocked configuration, as illustrated in FIG. 3B), inner retainer 304 may freely rotate relative to outer retainer 311. Outer retainer 311 may define one or more channels 314, each of channels 314 being sized to receive locking block(s) 308. Inner retainer 304 may define recesses 316 on an outer surface of inner retainer 304. Each of recesses 316 may be sized to receive at least a portion of locking block(s) 308. Fastener retention system 300 may insert each locking block 308 through a corresponding channel 314 and into a corresponding recess 316 to engage and/or secure inner retainer 304 to outer retainer 311, e.g., to transition fastener retention system 300 from the unlocked to the locked configuration. Fastener retention system 300 may retract each locking block 308 out of the corresponding recess 316 through the corresponding channel 314 to release inner retainer 304 from outer retainer 311, e.g., to transition fastener retention system 300 from the locked configuration to the unlocked configuration. In the unlocked configuration, fastener 104 may remain compressed within inner receptacle 306.

When inner retainer 304 is engaged to and/or secured to outer retainer 311, fastener retention system 300 may be in the locked configuration, e.g., as illustrated in FIG. 3B. In the locked configuration, inner retainer 304 may be inhibited from rotating about longitudinal axis 102 by outer retainer 311. In the locked configuration fastener 104 may be inserted and/or retracted from within inner receptacle 306. An authorized user may transition fastener retention system 300 from the unlocked configuration (e.g., as illustrated in FIG. 3B) to the locked configuration (e.g., as illustrated in FIG. 3A) prior to insertion of fastener 104 into inner receptacle 306 and/or prior to retraction of fastener 104 from within inner receptacle 306. Once the authorized user has completed the insertion or retraction of fastener 104, the authorized user may transition fastener retention system 300 to the unlocked configuration, e.g., to secure fastener 104 within fastener retention system 300 and inhibit unauthorized tampering with fastener 104. The authorized user may insert locking block(s) 308 into recess(es) 316 and/or retract locking block(s) 308 from recess(es) 316 via an actuation element (not pictured in FIGS. 3A, 3B). The actuation element may not be accessible from an exterior of chassis 106 and/or may only be accessible via a specific tool provided to the authorized user.

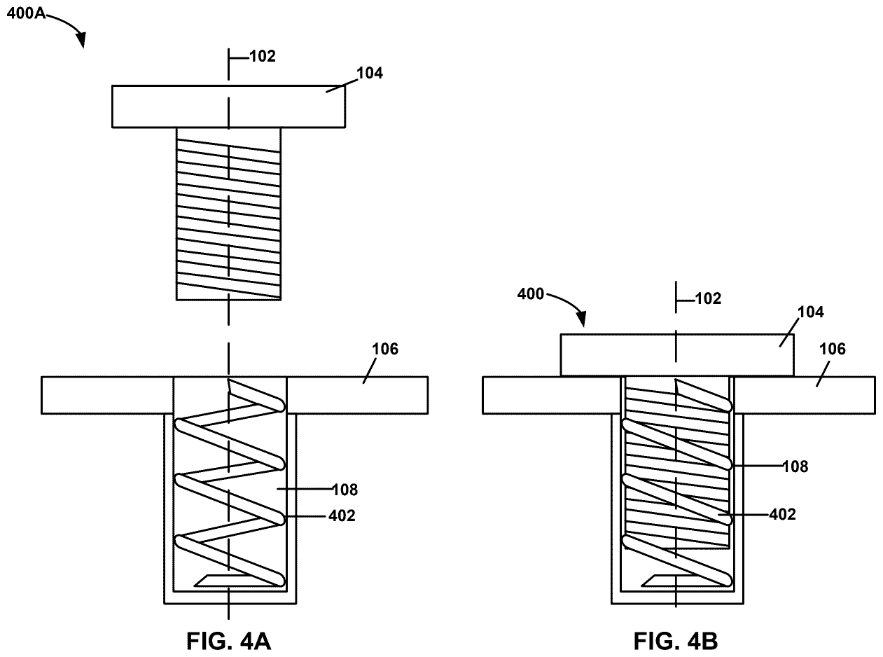

FIG. 4A is a conceptual diagram illustrating another example fastener retention system 400 for system 100 of FIG. 1. FIG. 4B is a conceptual diagram illustrating an interface between fastener 104 and fastener retention system 400 of FIG. 4A. Fastener retention system 400 may include an insert 402 disposed within receptacle 108. Insert 402 may include, but is not limited, to a helical spring or other fastener entangling and/or capturing device.

When fastener 104 is inserted into receptacle 108, insert 402 may wrap around an outer surface of fastener 104. When insert 402 is wrapped around the outer surface of fastener 104, insert 402 may increase a friction between fastener 104 and receptacle 108, e.g., inhibiting displacement of fastener 104 within receptacle 108. For example, portions of insert 402 may be disposed between corresponding features on fastener 104 and receptacle 108 (e.g., between male and female threads on fastener 104 and receptacle 108) to secure fastener 104 within receptacle 108. In some examples, if fastener 104 is removed from within receptacle 108 while insert 402 is wrapped around the outer surface of fastener 104, insert 402 may experience permanent deformation. The permanent deformation of insert 402 may inhibit removal of fastener 104 from within receptacle 108 and/or may provide a visual indicator to an authorized party that fastener 104 has been tampered with. Insert 402 may include, but is not limited to, a locking spring, a locking ribbon, a helical ribbon, or the like.

In some examples, insert 402 is wrapped around the outer surface of fastener 104 prior to insertion of fastener 104 into receptacle 108. In such examples, as fastener 104 is inserted into receptacle 108, portions of insert 402 may be disposed between fastener 104 and receptacle 108, e.g., to inhibit displacement of fastener 104 within receptacle 108 when fastener 104 is fully inserted within receptacle 108.

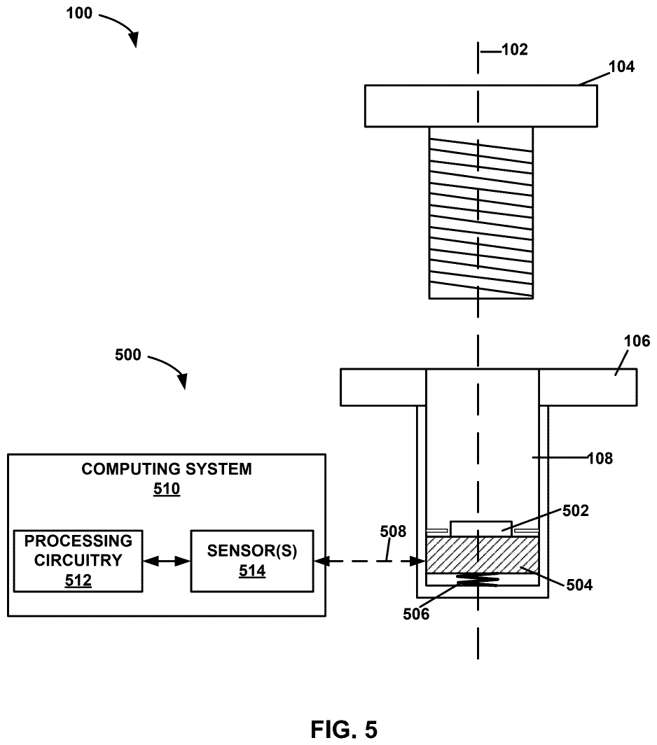

FIG. 5 is a conceptual diagram illustrating an example fastener monitoring system 500 for system 100 of FIG. 1. Fastener monitoring system 500 may be implemented within system 100 alongside an example fastener retention system (e.g., any of fastener retention systems 202, 300, 400). Fastener monitoring system 500 may include a first element 502, a second element 504, a spring 506, and a computing system 510. Computing system 510 may include, but is not limited to, processing circuitry 512 and sensor(s) 514. First element 502, second element 504, and spring 506 may be disposed within receptacle 108 of system 100.

Computing system 510 may be configured to monitor (e.g., via sensor(s) 514) position and/or displacement of first element 502, second element 504, and/or fastener 104 within fastener monitoring system 500. For example, computing system 510 may monitor the magnitude, frequency, and/or number of displacement of first element 502, second element 504 and/or fastener 104 along longitudinal axis 102. Processing circuitry 512 may identify possible tampering with fastener 104 based on the monitored information.

In some examples, an operator of fastener monitoring system 500 may manually identify (e.g., without using processing circuitry 512), whether fastener 104 has been tampered with based on displacement of first element 502, second element 504, and/or fastener 104.

First element 502 may include, but is not limited to, a plunger. When fastener 104 is disposed within receptacle 108, fastener 104 may contact and/or compress first element 502. When fastener is advanced further into receptacle 108, fastener 104 may further compress first element 502 towards a bottom of receptacle 108. When fastener is at least partially retracted from within receptacle 108, fastener 104 may allow an at least partial expansion of first element 502 back towards an uncompressed configuration. As first element 502 is compressed or uncompressed, first element 502 may cause a change in position of second element 504 (e.g., may cause second element 504 to rotate about longitudinal axis 102). For example, compression and/or decompression of first element 502 may cause spring 506 to cause second element 504 to rotate about longitudinal axis 102. Second element 504 may include, but is not limited to, a cam. Spring 506 may include, but is not limited to, a helical spring, a conical spring, or a leaf spring.

A magnitude of and/or direction of rotation for the change in position of second element 504 may be independent of a magnitude and/or direction of movement of first element 502 along longitudinal axis 102. For example, a same amount of compression or decompression of first element 502 in two or more instances may cause second element 504 to change position by two or more different magnitudes and/or in two or more different directions.

The magnitude and/or direction of the change in position of second element 504 being independent of the magnitude and/or direction of the compression of first element 502 may inhibit circumvention of fastener monitoring system 500. For example, with another fastener monitoring system where the magnitude and/or direction of rotation for the change in position of second element 504 is dependent on the magnitude and/or direction of movement of first element 502, an unauthorized third party may disassemble the other fastener monitoring system to determine the relationship between first element 502 and second element 504. Based on the determined relationship, the unauthorized third party may determine the initial positions of first and second elements 502, 504, e.g., prior to displacement of fastener 104 within receptacle 108. For example, the unauthorized third party may identify, within the other fastener monitoring system, a magnitude and/or direction of a change in position of second element 504 based on a magnitude of decompression of first element 502. The unauthorized third party may then remove fastener 104 and tamper with components of system 100, and then after tampering with components of system 100, re-position first element 502 and second element 504 back to initial positions prior to removal of fastener 104. In such examples, the unauthorized third party has bypassed the other fastener monitoring system by taking advantage of the dependency between first and second elements 502, 504.

In fastener monitoring system 500, the lack of the dependency between movements of first and second elements 502, 504 may inhibit the ability for the unauthorized third party to bypass fastener monitoring system 500, e.g., in the manner described above. Even if the unauthorized third party gains access to and disassembles fastener monitoring system 500, the unauthorized third party may not be able to determine the initial positions of first and second elements 502, 504. Therefore, the unauthorized third party would not be able to circumvent fastener monitoring system 500.

Computing system 510 may include sensor(s) 514 configured to sense signals 508 from second element 504. Sensor(s) 514 may include, but are not limited to, optical sensors, electrical sensors, or the like. Signals 508 may include, but are not limited to, an optical signal (e.g., an image of at least a portion of second element 504), an electrical current, or the like. Different portions of second element 504 (e.g., index elements on second element 504) may be distinct, e.g., include different visual identifiers (e.g., different colors, surface textures, markings, lenticular surfaces), define different electrical resistances, define different capacitances (e.g., exhibit parasitic capacitance), define include different materials (e.g., include dissimilar metals). Sensor(s) 514 may be directed towards a specific portion of receptacle 108 (e.g., around an inner perimeter of receptacle 108).

Processing circuitry 512 may passively read an orientation of second element 504 based on signals 508. In some examples, processing circuitry 512 is configured to actively read and/or record an orientation of second element 504 (e.g., a change in the orientation of second element 504, an orientation of second element 504 relative to first element 502). In some examples, processing circuitry 512 is configured to assign one or more different portions of second element 504 as index element(s). Processing circuitry 512 may read the position of second element 504 based on the changes in orientation of index element(s). Assigning index element(s) using processing circuitry 512 may inhibit the ability of the unauthorized third party to identify a pre-tampered configuration for second element 504 within fastener monitoring system 500, e.g., by disassembling fastener monitoring system 500.

Processing circuitry 512 may determine, based on signals 508, which portion of second element 504 is aligned with sensor(s) 514. Based on changes in signals 508, processing circuitry 512 may identify a change in position of second element 504 within receptacle 108. Processing circuitry 512 may determine a magnitude and/or direction of the change in position of second element 504. Based on the change in position of second element 504, processing circuitry 512 may determine that fastener 104 has been displaced and/or replaced within receptacle 108. Processing circuitry 512 may cause communications circuitry and/or a user interface (UI) of computing system 510 (not pictured in FIG. 5) to transmit a notification to an authorized user, e.g., indicating that fastener 104 has been displaced within receptacle 108. In some examples, processing circuitry 512 may store information corresponding to the determined fastener 104 displacement within memory of computing system 510 (not pictured in FIG. 5). An authorized user may retrieve the stored information from computing system 510, e.g., to determine whether fastener 104 has been tampered within a specific time period.

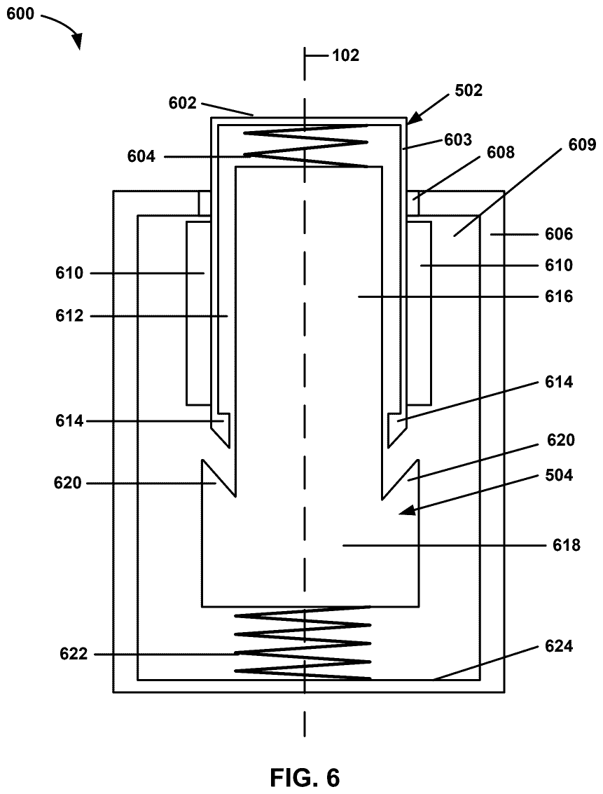

FIG. 6 is a conceptual diagram illustrating an example of the fastener monitoring system 500 of FIG. 5. The example of fastener monitoring system 500 illustrated in FIG. 6 may be alternatively referred to herein as “fastener monitoring system 600.” Fastener monitoring system 600 may be identical to fastener monitoring system 500, aside from the elements described below.

Fastener monitoring system 600 may include first element 502, second element 504, housing 606, and spring 622. First element 502 may extend at least partially out of housing 606. Second element 504 may be disposed within first element 502 and housing 606. Spring 622 may be configured to be disposed within housing 606. Housing 606 may be configured to be disposed within receptacle 108.

First element 502 may define a housing 603 defining a distal surface 602. Distal surface 602 may be configured to contact an end of fastener 104 as fastener 104 enters receptacle 108. Housing 603 may define an inner volume 612 and one or more appendages 614 at or around a proximal end of housing 603. Housing 603 may include one or more protrusions 610 extending radially outwards from the outer surface of housing 603. At least a portion of first element 502 may be disposed within inner volume 609 of housing 606. For examples, as illustrated in FIG. 6, a distal portion of first element 502 may extend out of housing 606 through opening 608 in housing 606 and a remainder of first element 502 (e.g., including protrusion(s) 610, appendage(s) 614) may be retained within inner volume 609. Protrusion(s) 610 may interface with housing 606 (e.g., with grooves and/or corresponding interface features in housing 606) to retain first element 502 at least partially within inner volume 609.

Second element 504 may define an elongated body 616 at least partially disposed within inner volume 612 of housing 603 of first element 502. Housing 603 may be coupled to elongated body 616 via spring 604. For example, an inner surface of housing 603 may be coupled to a distal surface of elongated body 16 via spring 604. Elongated body 616 may be connected to base 618. Second element 504 may include one or more protrusions 620 extending away (e.g., distally) from base 618. Second element 504 may be coupled to housing 606 via spring 622. For example, as illustrated in FIG. 6, a proximal surface of base 618 may be coupled to an inner surface of housing 606 via spring 622. Springs 604 and 622 may not inhibit rotation of second element 504 about longitudinal axis 102.

When fastener 104 is advanced into receptacle 108, a proximal end of faster 104 may contact distal surface 602 of first element 502 and push first element 502 proximally (e.g., into housing 606). As housing 603 of first element 502 is advanced proximally (e.g., into inner volume 609 of housing 606), appendage(s) 614 may engage with protrusion(s) 620 on second element 504 to apply a rotary force on second element 504, e.g., thereby causing second element 504 to rotate about longitudinal axis 102 in a first direction.

When fastener 104 is retracted from receptacle 108, a force applied by fastener 104 on distal surface 602 of first element 502 may decrease, e.g., thereby causing first element 502 to return towards an uncompressed configuration (e.g., via spring force(s) from springs 604 and/or 622). As housing 603 of first element 502 advances distally out of inner volume 609, appendage(s) 614 may no longer become engaged with protrusion(s) 620, which may cause second element 504 to rotate about longitudinal axis 102 in a second direction. The second direction may be the same as or opposite to the first direction. In some examples, protrusion(s) 620 may engage with features on an inner surface of housing 606 in addition to or instead of appendage(s) 614.

As second element 504 rotates about longitudinal axis 102, processing circuitry 512 of computing system 510 (not pictured in FIG. 6) may, via sensor(s) 514, detect a change in orientation of base 618 and/or reference point(s) on second element 504 and determine fastener 104 has been displaced within receptacle 108. Base 618 may include different identifiers (e.g., different visual identifiers, different electrical resistances, different electrical capacitances, different materials) at different positions around the circumference of base 618. Processing circuitry 512 may determine the change in orientation of base 618 based on a determination of a change in identifier of a portion of base 618 aligned with sensor(s) 514 of computing system 510. In some examples, processing circuitry 512 is configured to determine, based on the arrangement of the different identifiers around the circumference of base 618, a magnitude and/or direction of a rotation of second element 504 about longitudinal axis 102. Based on the determined magnitude and/or direction, processing circuitry 512 may determine a magnitude of displacement of fastener 104 within the receptacle 108 and/or a direction of displacement of fastener 104 within the receptacle 108 (e.g., further into receptacle 108, out of receptacle 108).

Spring 506 of fastener monitoring system 600 may include one or more of springs 604, 622. Springs 604, 622 may translate a force acting along longitudinal axis 102 and on distal surface 602 of first element 502 (e.g., from fastener 104) to a rotary force on second element 504. Springs 604, 622 may be disposed on opposite ends of second element 504. Inclusion of two or more springs (e.g., springs 604, 622) may cause a magnitude and/or direction of rotation of second element 504 to be independent of a magnitude and/or direction of translation of first element 502 along longitudinal axis 102.

The independence between translation of first element 502 and rotation of second element 504 may allow fastener monitoring system 500 to detect displacement of fastener 104 within receptacle 108 while inhibiting an unauthorized third party from bypassing fastener monitoring system 500. For example, with another fastener monitoring system with dependent first and second elements, an unauthorized third party may determine the rotation of the second element based on a specific translation by the first element. The unauthorized third party may then bypass detection of unauthorized tampering with fastener 104, e.g., by manipulating the fastener monitoring system to set the orientation of the second element to a pre-tampered configuration (i.e., a configuration of the second element prior to the unauthorized third party tampering with fastener 104). The independence of first and second elements 502, 504 (e.g., due to springs 604, 622) may inhibit the unauthorized third party from identifying the pre-tampered configuration based on a relationship between first and second elements 502, 504, thereby inhibiting potential bypass of fastener monitoring system 500.

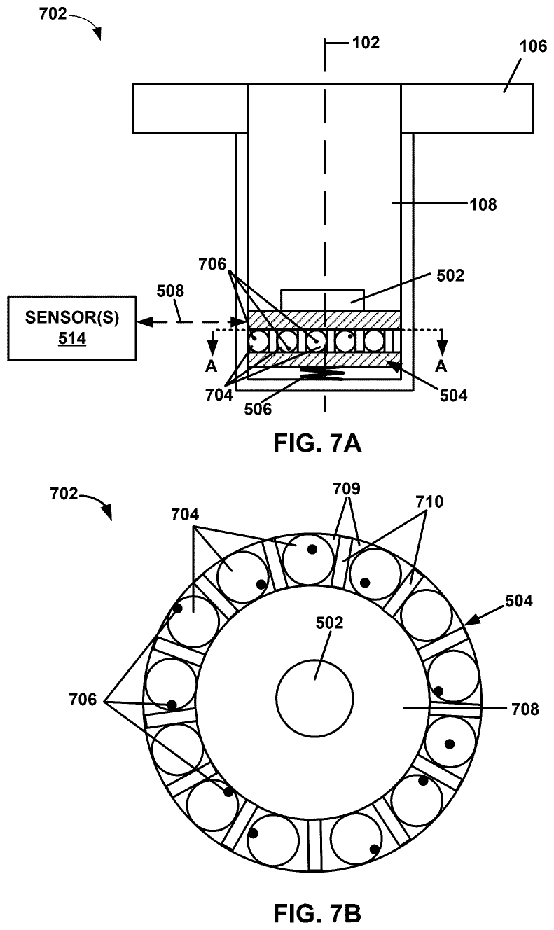

FIG. 7A is a conceptual diagram illustrating another example of fastener monitoring system 500 of FIG. 5. FIG. 7B is a cross-sectional diagram illustrating a cross-section of fastener monitoring system 500 of FIG. 7A, the cross-section being taken along line A-A of FIG. 7A. The example of fastener monitoring system 500 illustrated in FIGS. 7A-7B may be alternatively referred to herein as “fastener monitoring system 702.” Fastener monitoring system 702 may be identical to fastener monitoring system 500, aside from the elements described below. Fastener monitoring system 702 may include elements instead of or in addition to the elements described above with respect to fastener monitoring system 500 and/or fastener monitoring system 600.

Fastener monitoring system 702 may include first element 502, second element 504, and spring 506. Second element 504 may include an elongated body 708, a plurality of guide elements 710 extending from elongated body 708 and defining a plurality of chambers 709, and a plurality of rotational elements 704. Each rotational element 704 may be disposed within a corresponding chamber 709 of the plurality of chambers 709.

Rotational element 704 may define a spherical or a polygonal shape. Each rotational element 704 may be configured to move and/or rotate in all six degrees of freedom within chamber 709. Guide elements 710 may retain rotational elements 704 within the respective chambers 709. Each rotational element 704 may be, but is not limited to, a ball bearing.

In some examples, each chamber 709 includes one or more elements configured to interface with rotational element 704 to inhibit unintended movement of rotational element 704 within chamber 709, e.g., due to vibration within and/or movement of an entire system containing fastener monitoring system 702. In such examples, the one or more elements may inhibit rotational and/or movement of rotational element 704 within chamber 709 in response to a force (e.g., a vibrational force) with a magnitude less than or equal to a threshold value.

Each rotational element 704 may include one or more index elements 706. Index element(s) 706 may include an identifier including, but is not limited to, different visual identifiers, different electrical resistances, different electrical capacitances, different materials, or the like. Each index element 706 may be disposed on an outer surface of rotational element 704. Processing circuitry 122 of computing system 510 may monitor, via sensor(s) 514, index elements 706 (e.g., one index element 706, two or more index elements 706) for movement of rotational elements 704. Processing circuitry 122 may determine that fastener 104 has been displaced based on movement of rotational elements 704 within second element 504 (e.g., based on movement of index elements 706 of rotational elements 704).

When fastener 104 is displaced within receptacle 108, movement of first element 502 along longitudinal axis 102 in response may cause (e.g., via spring 506), rotation of second element 504 about longitudinal axis 102. As second element 504 rotates, elongated body 708 and/or guide elements 710 may cause rotational elements 704 travel at least partially about longitudinal axis 102 with second element 504. Movement of rotational elements 704 may cause each rotational element 704 to at least partially rotate along one or more axes, causing movement of index elements 706 on rotational elements 704. Processing circuitry 512 may identify the movement of index elements 706 and may determine, based on the movement of index elements 706, displacement of fastener 104 within receptacle 108.

Each rotational element 704 may freely move in all six degrees of freedom within a corresponding chamber 709. The magnitude and/or direction of movement of each rotational element 704 may be independent of movement of first element 502, of elongated body 708 of second element 504, and/or of any other rotational element 704. In such examples, the displacement and/or rotation of rotational elements 704 may be randomized (e.g., may be different for different instances of displacing first element 502 by a same magnitude and in a same direction). The random movements of rotational elements 704 may inhibit an unauthorized third party from identifying the pre-tampering positions and/or orientations of rotational elements 704, thereby inhibiting the unauthorized third party from bypassing fastener monitoring system 500. In some examples, index element(s) 706 are not visually distinctive, which may further inhibit identification of the pre-tampering positions by the unauthorized third party.

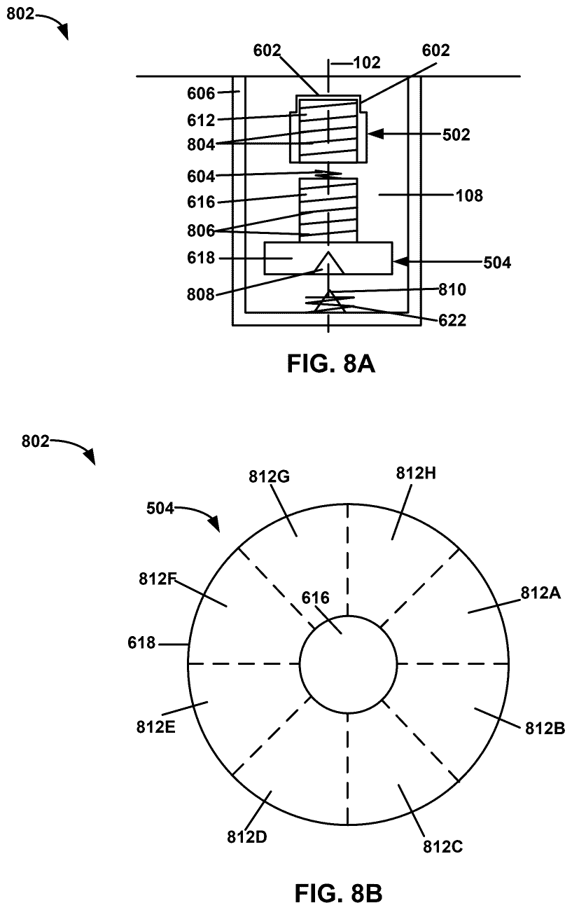

FIG. 8A is a conceptual diagram illustrating an exploded view of another example fastener monitoring system 500 of FIG. 5. FIG. 8B is a conceptual diagram illustrating a top view of fastener monitoring system 500 of FIG. 8A. Fastener monitoring system 500 illustrated in FIGS. 8A-8B may be alternatively referred to herein as “fastener monitoring system 802.” Fastener monitoring system 802 may be identical to fastener monitoring system 600, aside from the elements described below. Fastener monitoring system 802 may include elements instead of or in addition to the elements described above with respect to fastener monitoring system 500, fastener monitoring system 600, and/or fastener monitoring system 702.

In some examples, instead of or in addition to appendage(s) 614 and protrusion(s) 620 as illustrated in FIG. 6, fastener monitoring system 802 may include helical features 804, 806, e.g., to translate a force along longitudinal axis 102 and acting on first element 502 (e.g., on distal surface 602) to a rotary force about longitudinal axis 102 on second element 504. First helical features 804 may be disposed within an inner surface of housing 603 of first element 502. Second helical features 806 may be disposed around an outer surface of second element 504, e.g., around an outer surface of elongated body 616. First helical features 804 may interface with second helical features 806 to cause second element 504 to rotate in response to displacement of first element 502 further into or out of receptacle 108 (e.g., in response to displacement of fastener 104 within receptacle 108).

Springs 604, 622 may cause second element 504 to rotate about longitudinal axis 102. Springs 604, 622 may make the magnitude and/or direction of rotation of second element 504 independent of the magnitude and/or direction of movement of first element 502 along longitudinal axis 102. For example, springs 604, 622 may compress to cause second element 504 to rotate freely about longitudinal axis 102 in response to the movement of first element 502. A spindle 810 may be disposed within receptacle 108. Spindle 810 may interface with a corresponding recess 808 on a proximal surface of base 618, e.g., to maintain stability of second element 504 when second element 504 rotates about longitudinal axis 102. Spring 622 may be disposed around spindle 810 and may be coupled to base 618 of second element 504 and/or to housing 606.

Second element 504 may include a plurality of regions 812A-H, e.g., on base 618. Regions 812A-H may be alternatively referred to herein as “regions 812” Each of regions 812 may define a different index element of second element 504. While FIG. 8B illustrates second element 504 with 8 regions 812, other example second elements 504 described herein may include between 2 to 7 regions 812 or 9 or more regions 812. Regions 812 may include different visual identifiers, define different electrical resistances, define difference electrical capacitances, include different materials, or the like.

Sensor(s) 514 of computing system 510 may be directed at one or more specific locations around an inner perimeter of receptacle 108. As second element 504 rotates within receptacle 108 (e.g., in response to displacement of fastener 104 within receptacle 108), different regions 812 may become circumferentially aligned with sensor(s) 514. Sensor(s) 514 may sense signals 508 from regions 812 and processing circuitry 512 may determine, based on signals 508, whether sensor(s) 514 are sensing signals 508 from different regions 812 within a time period. Based on a determination that sensor(s) 514 are sensing signals 508 from different regions 812, processing circuitry 512 may determine that second element 504 has rotated about longitudinal axis 102. Based on the determination, processing circuitry 512 may determine that fastener 104 has been displaced within receptacle 108.

In some examples, regions 812 are permanently set within base 618. In some examples, regions 812 may be adjustable by computing system 510. For example, processing circuitry 512 may select any combination of region(s) 812 as a pre-tampered configuration to compare signals 508 against.

Springs 604, 622, may cause the magnitude and/or direction of rotation of second element 504 to be independent of the magnitude and/or direction of movement of first element 502. In such examples, each movement of first element 502 causes a different rotation of second element 504, e.g., thereby inhibiting a determination of which region 812 is aligned with each sensor 514 when second element 504 is in the pre-tampered configuration. In some examples, each of regions 812 may be visually identical, which may further inhibit the determination of which region 812 is aligned with each sensor 514 when second element 504 is in the pre-tampered configuration.

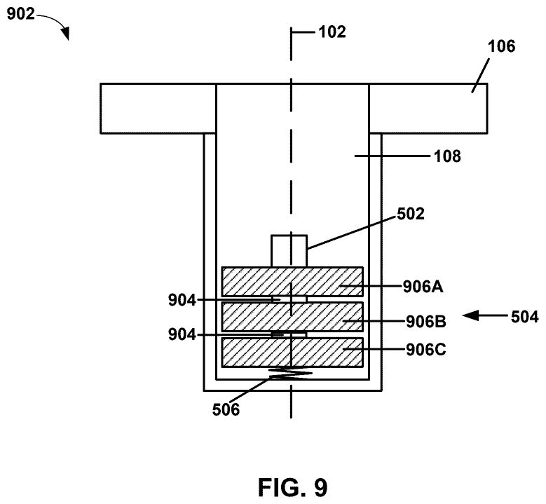

FIG. 9 is a conceptual diagram illustrating an exploded view of another example of fastener monitoring system 500 of FIG. 5. The example of fastener monitoring system 500 illustrated in FIG. 9 may be alternatively referred to herein as fastener monitoring system 500. Fastener monitoring system 902 may be identical to any of fastener monitoring systems 600, 802, or 702, aside from the elements described below.

Fastener monitoring system 902 may include first element 502, second element 504, spring 506, and computing system 510 (not pictured). Second element 504 may include a plurality of rotational elements 906A-C (collectively referred to herein as “rotational elements 906”). While FIG. 9 illustrates second element 504 with three rotational elements 906, other examples of fastener monitoring system 902 may include second element 504 with two or four or more rotational elements 906.

Fastener monitoring system 902 may include a plurality of springs 904. Each rotational element 906 may be coupled to longitudinally adjacent rotational elements 906 via one spring 904. For example, as illustrated in FIG. 9, rotational element 906B may be coupled to rotational element 906A by one spring 904 and to rotational element 906C by another spring 904. Each rotational element 906 may include one or more index elements disposed at one or more positions around a circumference of rotational element 906. Each rotational element 906 may be substantially similar to base 618 of fastener monitoring system 600 or of fastener monitoring system 902 or to elongated body 708 of fastener monitoring system 702. For examples, each rotational element 906 may include a plurality of regions 812 or is attached to a plurality of guide elements 710 containing rotational elements 704, e.g., as previously described herein with respect to fastener monitoring systems 802 and 702, respectively.

In some examples, at least one rotational element 906 is at least partially nested within a longitudinally adjacent rotational element 906. For example, one rotational element 906 may include a recess 808 or spindle 810 configured to interface with a respective spindle 810 or recess 808 on a longitudinally adjacent rotational element 906.

First element 502 may be coupled to a distal-most rotational element (e.g., rotational element 906A, as illustrated in FIG. 9). Displacement of first element 502 along longitudinal axis 102 may cause the rotational element 906A to rotate about longitudinal axis 102. Rotation of rotational element 906A may cause spring 904 attached to the rotational element 906A to cause a longitudinally adjacent rotational element (e.g., rotational element 906B) to rotate about longitudinal axis 102. Subsequent rotational elements 906 may be caused to rotate about longitudinal axis 102 via springs 904 between rotational elements 906. In conjunction, the displacement of first element 502 may cause all rotational elements 906 to begin rotating about longitudinal axis 102. Each rotational element 906 may rotate at a different magnitude and in a different direction from one or more other rotational elements 906. The magnitude and/or direction of the displacement of first element 502 may be independent of the magnitude and/or direction of rotation for one or more of rotational elements 906.

Sensor(s) 514 of computing system 510 may include one or more sensors 514 corresponding to each rotational element 906. For each rotational element 906, the corresponding one or more sensors 514 may monitor for rotation of rotational element 906 (e.g., a change in position and/or orientation of index element(s) of rotational element 906). Processing circuitry 512 may determine that fastener 104 has been tampered with based on a determination that at least one of rotational elements 906 has been rotated about longitudinal axis 102. Including two or more rotational elements 906 that may rotate independently in response to displacement of first element 502 may increase a complexity of a pre-tampering configuration for second element 504, e.g., thereby inhibiting potential bypass of fastener monitoring system 500 by an unauthorized third party.

The techniques of this disclosure may also be described in the following examples.

Example 1A: a device comprising: a first element configured to contact a component of a system; a second element disposed at least partially within and configured to interface with the first element; and processing circuitry coupled to the first element and the second element, the processing circuitry being configured to: determine a rotation of the second element relative to the first element in response to a movement of the component within the system; and output, based on the determination, a notification indicating a displacement of the component within the system.

Example 2A: the device of example 1A, further comprising an index element disposed on at least one of the first element or the second element, and wherein to determine the rotation of the second element relative to the first element, the processing circuitry is configured to: determine a position of the index element within the device; and determine the rotation of the second element relative to the first element based on a change in the position of the index element.

Example 3A: the device of example 2A, wherein the index element comprises one or more of: a region on one or more of the first element or the second element with a dissimilar metal; a region on one or more of the first element or the second element exhibiting parasitic capacitance; a region on one or more of the first element or the second element with a different electrical resistance; a region on one or more of the first element or the second element with a surface texture; or a region on one or more of the first element or the second element with a lenticular surface.

Example 4A: the device of any of examples 1A-3A, wherein the first element is configured to move along a longitudinal axis of the device in response to the movement of the component, and wherein the movement of the first element along the longitudinal axis causes the second element to rotate relative to the first element.

Example 5A: the device of example 4A, wherein a magnitude of the rotation of the second element is independent from a magnitude of the movement of the first element.

Example 6A: the device of any of examples 1A-5A, wherein the component of the system comprises a mechanical fastener within the system.

Example 7A: the device of example 6A, wherein to output, based on the determination, the notification indicating the displacement of the component within the system, the processing circuitry is configured to: determine, based on the determination, that the mechanical fastener has been displaced within the system; and output, based on a determination of displacement of the mechanical fastener within the system, the notification indicating that the mechanical fastener of the system has been tampered with.

Example 8A: the device of any of examples 1A-7A, wherein the second element comprises one or more rotational elements, each rotational element of the one or more rotational elements defining an index element, wherein each rotational element is configured to rotate within the second element in response to the rotation of the second element, and wherein to determine the rotation of the second element relative to the first element in response the movement of the component, the processing circuitry is configured to: determine the rotation of at least one rotational element of the one or more rotational elements within the second element based on a change in a position of the index element of the at least one rotational element.

Example 9A: the device of any of examples 1A-8A, wherein the second element comprises two or more rotational elements, each rotational element being configured to rotate about a longitudinal axis of the device and relative to the first element in response to a movement of the component within the system, and wherein to determine the rotation of the second element relative to the first element in response the movement of the component, the processing circuitry is configured to: determine the rotation of at least one rotational element of the two or more rotational elements about the longitudinal axis.

Example 10A: the device of any of examples 1A-9A, wherein the processing circuitry is further configured to determine an index position along the second element, and wherein to determine the rotation of the second element relative to the first element, the processing circuitry is configured to determine a change in position of the index position about a longitudinal axis of the device.

Example 11A: a device comprising: a first element configured to contact a fastener of a system, wherein the first element is configured to move along a longitudinal axis of the device in response to movement of the fastener within the system; a second element disposed at least partially within and configured to interface with the first element, the second element comprising: an elongated body configured to interface with the first element, a plurality of guide elements extending from the elongated body and defining a plurality of recesses around the elongated body, and a plurality of rotational elements, each rotational element of the plurality of rotational elements being disposed within a corresponding recess of the plurality of recesses, wherein each rotational element is configured to rotate within the corresponding recess; and processing circuitry coupled to the first element and the second element, the processing circuitry being configured to: determine a rotation of one or more rotational elements of the plurality of rotational elements in response to the movement of the fastener; and output, based on the determination, a notification indicating a displacement of the fastener within the system.

Example 12A: the device of example 11A, wherein each rotational element of the plurality of rotational elements comprises an index element disposed on the rotational element, and wherein to determine the rotation of the one or more rotational elements, the processing circuitry is configured to: determine a position of the index element for each rotational element of the one or more rotational elements; and determine a change in position of the index element for each rotational element of the one or more rotational elements.

Example 13A: the device of example 12A, wherein the index element comprises one or more of: a region on each rotational element of the plurality of rotational elements with a dissimilar metal; a region on an outer surface of each rotational element of the plurality of rotational elements with a visual identifier; a region on each rotational element of the plurality of rotational elements exhibiting parasitic capacitance; a region on each rotational element of the plurality of rotational elements exhibiting a different resistance; a region on each rotational element of the plurality of rotational elements with a surface texture; or a region on each rotational element of the plurality of rotational elements with a lenticular surface.

Example 14A: the device of any of examples 11A-13A, wherein each rotational element of the plurality of rotational element defines a spherical shape.

Example 15A: the device of any of examples 11A-14A, wherein a magnitude of the rotation of each rotational element of the one or more rotational elements is independent of a magnitude of the movement of the fastener.

Example 16A: a device comprising: a first element configured to contact a fastener of a system, wherein the first element is configured to move along a longitudinal axis of the device in response to movement of the fastener within the system; a plurality of rotational elements, wherein at least one rotational element of the plurality of rotational elements is configured to interface with the first element, wherein each rotational element is coupled to at least one other rotational element of the plurality of rotational elements, and wherein each rotational element of the plurality of rotational elements is configured to rotate about the longitudinal axis in response to the movement of the first element along the longitudinal axis; and processing circuitry coupled to the first element and the second element, the processing circuitry being configured to: determine a rotation of one or more rotational elements of the plurality of rotational elements in response to the movement of the fastener; and output, based on the determination, a notification indicating a displacement of the fastener within the system.

Example 17A: the device of example 16A, wherein longitudinally adjacent rotational elements of the plurality of rotational elements are connected by one or more of a spring or a spindle disposed between the longitudinally adjacent rotational elements, and wherein longitudinally adjacent rotational elements are configured to rotate relative to each other in response to the movement of the first element.

Example 18A: the device of any of examples 16A and 17A, wherein each rotational element of the plurality of rotational elements is configured to rotate about the longitudinal axis by a different amount in response to the movement of the first element.

Example 19A: the device of any of examples 16A-18A, wherein each rotational element of the plurality of rotational elements comprises an index element disposed on the rotational element, and wherein to determine the rotation of the one or more rotational elements, the processing circuitry is configured to: determine a position of the index element for each rotational element of the one or more rotational elements; and determine a change in position of the index element for each rotational element of the one or more rotational elements.

Example 20A: the device of example 19A, wherein the index element comprises one or more of: a region on each rotational element of the plurality of rotational elements with a dissimilar metal; a region on an outer surface of each rotational element of the plurality of rotational elements with a visual identifier; a region on each rotational element of the plurality of rotational elements exhibiting parasitic capacitance; a region on each rotational element of the plurality of rotational elements exhibiting a different resistance; a region on each rotational element of the plurality of rotational elements with a surface texture; or a region on each rotational element of the plurality of rotational elements with a lenticular surface.

Example 21A: a device comprising: a first element configured to contact a component of a system; and a second element disposed at least partially within and configured to interface with the first element, wherein the second element is configured to rotate relative to the first element in response to a movement of the component within the system, and wherein the rotation of the second element is configured to provide an indication of a displacement of the component within the system.

Example 22A: the device of example 21A, further comprising one or more elements of any of examples 2A-20A.

Example 1B: a fastener retention system comprising: a fastener; a recess configured to receive the fastener; and one or more retention elements disposed within the recess, wherein the one or more retention elements are configured to interface with the fastener when the fastener is disposed within the recess to retain the fastener within the recess and inhibit unintended movement of the fastener within the recess.

Example 2B: the fastener retention system of example 1B, wherein the one or more retention elements comprises: a first element disposed within the recess; and one or more second elements coupled to the first element, wherein the one or more second elements are configured to apply a compressive force on the fastener in response to the fastener contacting the first element, wherein the compressive force inhibits the unintended movement of the fastener.

Example 3B: the fastener retention system of example 2B, wherein the one or more second elements are configured to apply the compressive force orthogonal to a longitudinal axis of the fastener retention system in response to the fastener applying a force on the first element along the longitudinal axis.

Example 4B: the fastener retention system of any of examples 2B and 3B, wherein the one or more second elements are configured to clamp around the fastener in response to the fastener contacting the first element.

Example 5B: the fastener retention system of any of examples 2B-4B, wherein the first element is coupled to a spring, wherein the first element is configured to receive a force from the fastener, and wherein the spring is configured to transfer the received force to the one or more second elements to cause the one or more second elements to apply the compressive force on the fastener.

Example 6B: the fastener retention system of any of examples 2B-5B, wherein each second element of the one or more second elements is coupled to the first element via one or more of: one or more levers; or one or more springs.

Example 7B: the fastener retention system of any of examples 1B-6B, wherein the fastener and the recess are a part of a Micro-Electro-Mechanical Systems (MEMS) device.

Example 8B: the fastener retention system of any of examples 1B-7B, wherein the one or more retention elements comprises: a first sleeve configured to receive the fastener; and a second sleeve disposed within the recess, the second sleeve being configured to be removable engaged to the first sleeve, wherein when the second sleeve is engaged to the first sleeve, the fastener is configured to be advanced into or retracted from within the recess, and wherein when the second sleeve is not engaged to the first sleeve, the fastener is configured to freely rotate within the recess without being advanced into or retracted from within the recess.

Example 9B: the fastener retention system of any of examples 1B-8B, wherein the one or more retention elements comprises a locking spring disposed within the recess, and wherein the locking spring is configured to envelop the fastener as the fastener enters the recess to secure the fastener within the recess.

Example 10B: a fastener retention system comprising: a fastener; a recess; and a locking system disposed within the recess, the locking system comprising: a first sleeve configured to receive the fastener, and a second sleeve disposed within the recess and sized to retain first sleeve, the second sleeve being configured to be removably engaged to the first sleeve; wherein when the second sleeve is engaged to the first sleeve, the locking system allows for movement of the fastener into and out of the locking system, and wherein when the second sleeve is not engaged to the first sleeve, the locking system inhibits the movement of the fastener into and out of the locking system.

Example 11B: the fastener retention system of example 10B, wherein the second sleeve is affixed to the recess, and wherein when the second sleeve is engaged to the first sleeve, the first sleeve is affixed to the second sleeve.

Example 12B. The fastener retention system of example 11B, wherein when the first sleeve is affixed to the second sleeve, the second sleeve inhibits rotation of the first sleeve within the second sleeve.

Example 13B: the fastener retention system of any of examples 10B-12B, wherein when the second sleeve is not engaged to the first sleeve, the first sleeve is configured to freely rotate within the second sleeve.

Example 14B: the fastener retention system of example 13B, further comprising a plurality of bearings disposed between the first sleeve and the second sleeve, wherein the plurality of bearings allow for the free rotation of the first sleeve within the second sleeve when the second sleeve is not engaged to the first sleeve.

Example 15B: the fastener retention system of any of examples 10B-14B, further comprising one or more locking elements protruding from the second sleeve, wherein the first sleeve defines one or more locking recesses along an outer surface of the first sleeve, and wherein the one or more locking elements are configured to interface with the one or more locking recesses to engage the second sleeve to the first sleeve.

Example 16B: the fastener retention system of example 15B, wherein each locking element of the one or more locking elements is configured to be advanced towards the first sleeve and retracted away from the first sleeve.

Example 17B: the fastener retentions system of any of examples 10B-16B, wherein the recess extends proximally along a longitudinal axis from a surface, wherein a distal opening of the recess is flush with the surface, and wherein the first sleeve defines a collar at a distal end of the first sleeve, the collar being proud of the surface.

Example 18B: a fastener retention system comprising: a fastener; a recess configured to receive the fastener; and a locking spring disposed within the recess, wherein the locking spring is configured to envelop the fastener as the fastener enters the recess to secure the fastener within the recess.

Example 19B: the fastener retention system of example 18B, wherein the locking spring defines a helical spring.

Example 20B: the fastener retention system of any of examples 18B and 19B, wherein the locking spring envelops the fastener to inhibit removal of the fastener from within the recess.

In one or more examples, the functions described above may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

The term “non-transitory” may indicate that the storage medium is not embodied in a carrier wave or a propagated signal. In certain examples, a non-transitory storage medium may store data that can, over time, change (e.g., in RAM or cache). By way of example, and not limitation, such computer-readable storage media, may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor” and “processing circuitry,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. These and other examples are within the scope of the following claims.

What is claimed is:

1. A fastener retention system comprising:
a fastener;
a recess configured to receive the fastener; and
one or more retention elements disposed within the recess, wherein the one or more retention elements are configured to interface with the fastener when the fastener is disposed within the recess to retain the fastener within the recess and inhibit unintended movement of the fastener within the recess.

2. The fastener retention system of claim 1, wherein the one or more retention elements comprises:
a first element disposed within the recess; and
one or more second elements coupled to the first element,
wherein the one or more second elements are configured to apply a compressive force on the fastener in response to the fastener contacting the first element, wherein the compressive force inhibits the unintended movement of the fastener.

3. The fastener retention system of claim 2, wherein the one or more second elements are configured to apply the compressive force orthogonal to a longitudinal axis of the fastener retention system in response to the fastener applying a force on the first element along the longitudinal axis.

4. The fastener retention system of claim 2, wherein the one or more second elements are configured to clamp around the fastener in response to the fastener contacting the first element.

5. The fastener retention system of claim 2, wherein the first element is coupled to a spring, wherein the first element is configured to receive a force from the fastener, and wherein the spring is configured to transfer the received force to the one or more second elements to cause the one or more second elements to apply the compressive force on the fastener.

6. The fastener retention system of claim 2, wherein each second element of the one or more second elements is coupled to the first element via one or more of:
one or more levers; or
one or more springs.

7. The fastener retention system of claim 1, wherein the fastener and the recess are a part of a Micro-Electro-Mechanical Systems (MEMS) device.

8. The fastener retention system of claim 1, wherein the one or more retention elements comprises:
a first sleeve configured to receive the fastener; and
a second sleeve disposed within the recess, the second sleeve being configured to be removable engaged to the first sleeve,
wherein when the second sleeve is engaged to the first sleeve, the fastener is configured to be advanced into or retracted from within the recess, and
wherein when the second sleeve is not engaged to the first sleeve, the fastener is configured to freely rotate within the recess without being advanced into or retracted from within the recess.

9. The fastener retention system of claim 1,
wherein the one or more retention elements comprises one or more of a locking spring or a locking ribbon disposed within the recess, and
wherein the locking spring is configured to envelop the fastener as the fastener enters the recess to secure the fastener within the recess.

10. A fastener retention system comprising:
a fastener;
a recess; and
a locking system disposed within the recess, the locking system comprising:
a first sleeve configured to receive the fastener, and
a second sleeve disposed within the recess and sized to retain first sleeve, the second sleeve being configured to be removably engaged to the first sleeve;
wherein when the second sleeve is engaged to the first sleeve, the locking system allows for movement of the fastener into and out of the locking system, and
wherein when the second sleeve is not engaged to the first sleeve, the locking system inhibits the movement of the fastener into and out of the locking system.

11. The fastener retention system of claim 10, wherein the second sleeve is affixed to the recess, and wherein when the second sleeve is engaged to the first sleeve, the first sleeve is affixed to the second sleeve.

12. The fastener retention system of claim 11, wherein when the first sleeve is affixed to the second sleeve, the second sleeve inhibits rotation of the first sleeve within the second sleeve.

13. The fastener retention system of claim 10, wherein when the second sleeve is not engaged to the first sleeve, the first sleeve is configured to freely rotate within the second sleeve.

14. The fastener retention system of claim 13, further comprising a plurality of bearings disposed between the first sleeve and the second sleeve, wherein the plurality of bearings allow for the free rotation of the first sleeve within the second sleeve when the second sleeve is not engaged to the first sleeve.

15. The fastener retention system of claim 10, further comprising one or more locking elements protruding from the second sleeve, wherein the first sleeve defines one or more locking recesses along an outer surface of the first sleeve, and wherein the one or more locking elements are configured to interface with the one or more locking recesses to engage the second sleeve to the first sleeve.

16. The fastener retention system of claim 15, wherein each locking element of the one or more locking elements is configured to be advanced towards the first sleeve and retracted away from the first sleeve.

17. The fastener retentions system of claim 10, wherein the recess extends proximally along a longitudinal axis from a surface, wherein a distal opening of the recess is flush with the surface, and wherein the first sleeve defines a collar at a distal end of the first sleeve, the collar being proud of the surface.

18. A fastener retention system comprising:
a fastener;
a recess configured to receive the fastener; and
an insert disposed within the recess, wherein the insert is configured to envelop the fastener as the fastener enters the recess to secure the fastener within the recess.

19. The fastener retention system of claim 18, wherein the insert comprises one or more of:
a helical spring; or
a helical insert.

20. The fastener retention system of claim 18, wherein the insert envelops the fastener to inhibit removal of the fastener from within the recess.
